(19) United States
(12) Patent Application Publication
(10) Pub. No.: US 2008/0199774 A1
(43) Pub. Date: Aug. 21, 2008

(54) Membrane electrode assembly with electrode support

(75) Inventors: Sarbjit Singh Giddey, Glen Waverley (AU); Fabio T. Ciacchi, Clayton (AU); Sukhvinder P.S. Badwal, Clayton (AU)

Correspondence Address: LAHIVE & COCKFIELD, LLP, ONE POST OFFICE SQUARE, BOSTON, MA, 02109, US

(73) Assignee: Commonwealth Scientific and Industrial Research Organisation, Campbell (AU)

(21) Appl. No.: 11/708,176

(22) Filed: Feb. 20, 2007

(51) Int. Cl. H01M 4/02

(52) U.S. Cl. 429/209; 29/623.1; 29/623.4; 29/623.5

(57) ABSTRACT

A membrane electrode assembly (MEA) for an electrochemical cell including: a first electrode; a second electrode; and a proton exchange membrane (PEM) interposed between the first and second electrodes such that protons can pass between the first and second electrodes across the PEM; wherein the first electrode has a foraminous metallic substrate to provide support for the PEM.

### FIELD OF THE INVENTION

The present invention relates to membrane electrode assemblies for electrochemical cells. The invention has been primarily developed for use in proton exchange membrane based water electrolysis cells to generate hydrogen at ambient or high pressures, and will be described herein by particular reference to that application. However, the invention is by no means restricted as such, and has various alternate applications in a broader context.

### BACKGROUND

A polymer electrolyte membrane electrolysis stack consists of a number of membrane electrode assemblies (MEAs) assembled together in series by using bipolar interconnect plates to produce required hydrogen flow rates. Each MEA consists of a proton exchange membrane (PEM), in the form of a polymer electrolyte membrane, sandwiched between a hydrogen electrode (cathode) and an oxygen electrode (anode). Water supplied to the anode is dissociated into protons, oxygen and electrons. The electrons travel through the outer circuit and the protons are transported through the membrane to the cathode, where they combine with the electrons to produce hydrogen as per the following reactions:

at anode (oxygen electrode),H₂O=2H⁺+½O₂+2e

at cathode (hydrogen electrode),2H⁺+2e=H₂

The above electrochemical reactions occur at the triple phase boundaries (catalyst—ionomer—reactant) at the electrode/electrolyte interface of the MEA. The catalyst facilitates the reaction and conducts electrons to or from reaction sites. The ionomer (membrane) conducts protons to or from reaction sites. The catalyst which is not accessible to the reactants and not in contact with the ionomer is not utilised in the electrochemical reactions. Therefore, it is absolutely critical to maximise the triple phase boundaries for carrying out the reactions efficiently and maximising the catalyst utilisation. Furthermore, maximising the electron conduction between each electrode and the interconnect as well as between the catalyst and each electrode, reactant (water) accessibility, and product (oxygen and hydrogen) transport to/from reaction sites are essential to minimising losses due to ohmic and concentration polarisation.

The major voltage losses in an electrolysis cell, apart from the electrolyte membrane, are attributed to the oxygen evolution reaction. In order to minimise these (overvoltage) losses, the electrode/electrolyte interface has to be designed and fabricated in such a way as to maximise the number of electrochemical reaction sites (triple phase boundaries—water, catalyst and electrolyte). Thus, the electrode/electrolyte interface is required to have excellent electrical conductivity for electron exchange, as well as allow for proper fluid (water and oxygen) exchange between the flow fields (ribs and channels) of the interconnect and the interface. Therefore, the electrode/electrolyte interface has to meet a number of criteria to fulfil its function and keep the voltage losses at the oxygen electrode to a minimum.

In a conventional fuel cell oxygen electrode/electrolyte interface, this is achieved (for the oxygen reduction reaction) by putting a catalyst/ionomer layer on a carbon paper (or cloth) substrate. However, the oxidising atmosphere on the oxygen electrode, in the case of electrolysis, limits the available substrate materials that can be used in this environment. Graphite, for example, is unstable in oxidising environments.

In order to increase the energy density in terms of kilojoules per unit volume, the hydrogen generated needs to be compressed to higher pressures. For many applications, pressurisation of hydrogen to 10 to 20 bar pressure is sufficient. Normally this is achieved through mechanical compression. However, it is well known that electrochemical compression is considerably more efficient than external mechanical compression. Thus, it would be beneficial to generate hydrogen at high pressures, where its storage would become easier and more cost effective.

In order to generate hydrogen at high pressures, however, some kind of support means is needed on the water supply or oxygen generation side of the MEA to avoid damage to the membrane. At the same time, water must still be available at contacts between the catalyst and the proton conducting exchange membrane, and oxygen formed at reaction sites must be allowed to escape freely. In addition, the support means will be in series with cell components, and therefore, must be a good electrical conductor, resist corrosion and oxidation by the oxygen produced in the reaction, and offer a maximised number of contact sites between the water, the catalyst, and the membrane.

U.S. Pat. No. 6,916,443 (Skoczylas et al.) discloses a support means for the oxygen electrode that includes a sintered titanium plate having approximately 50% porosity. Together with a catalyst ink and binder, the sintered titanium plate forms the oxygen electrode. The sintered titanium plate electrode is used in an electrolysis cell stack with the following components configured in the order recited: a separator plate, a screen pack, the sintered titanium plate, electrode, a Nafion membrane, electrode, a second screen pack, a shim, a pressure pad, and another separator plate. A stainless steel ring is fitted around the cell frames to hold the components together and to provide lateral strength for high pressure operation. Thus, this electrolysis cell comprises a number of separate components, and therefore, requires quite a number of assembly steps.

### SUMMARY OF THE INVENTION

It is an object of the present invention to provide an improved membrane electrode assembly with electrode support.

In accordance with a first aspect of the present invention, there is provided a membrane electrode assembly (MEA) for an electrochemical cell including: a first electrode; a second electrode; and a proton exchange membrane (PEM) interposed between the first and second electrodes such that protons can pass between the first and second electrodes across the PEM; wherein the first electrode has a foraminous metallic substrate to provide support for the PEM.

The first electrode and the PEM are preferably integrally bonded together. The second electrode and the PEM are preferably integrally bonded together. More preferably, the first electrode, PEM, and second electrode are hot pressed together.

Preferably, the foraminous metallic substrate has a predetermined proportion of open area and a predetermined contact area, the open area being configured to optimise the flow of a predetermined fluid through the open area, whilst optimising the contact area available as electrochemical reaction sites.

The foraminous metallic substrate can be a mesh defined by a first plurality of generally parallel metallic wires weaved together with a second plurality of generally parallel metallic wires disposed generally orthogonal to the first plurality of wires.

In one embodiment, each wire passes alternately over and under another wire. In another embodiment, each wire passes alternately over two other wires and under two further wires.

The substrate can be pressed to reduce the thickness of the substrate. The mesh can be pressed to increase the contact between the wires. The mesh can be pressed to reduce the undulations of the woven wires.

The mesh can be pressed to optimise the proportion of open area and the contact area, such that the fluid flow to and from the interface between the first electrode and the PEM, and the contact between the first electrode and the PEM are optimised.

The foraminous metallic substrate preferably has a coating that includes a catalyst. Preferably, the coating includes an oxygen evolving catalyst. The coating preferably includes an ionomer. More preferably, the coating includes a catalyst ink having a noble metal catalyst powder and an ionomer.

The foraminous metallic substrate preferably has a coating that includes platinum. The foraminous metallic substrate can have a coating that includes one or more of palladium, nickel, gold, silver, and alloys constituting one or more of palladium, nickel, gold, and silver. In one embodiment, the foraminous metallic substrate has a corrosion protection coating. In another embodiment, the foraminous metallic substrate has a built-in corrosion protection mechanism.

The foraminous metallic substrate preferably can be made of titanium. The foraminous metallic substrate can be made of one or more of stainless steel, mild steel, nickel, niobium, and tantalum. The foraminous metallic substrate can be in the form of a multi-perforate metallic sheet. The foraminous metallic substrate can be in the form of a porous metallic sheet.

In one embodiment, the PEM has a coating that includes an oxygen evolving catalyst, and the foraminous metallic substrate has a corrosion protection coating, with the first electrode, the PEM, and the second electrode being hot pressed together.

In accordance with a further aspect of the present invention, there is provided a method of manufacturing a membrane electrode assembly, the method including the steps of: manufacturing a first electrode having a foraminous metallic substrate; manufacturing a second electrode; treating a proton exchange membrane (PEM); interposing the PEM between the first and second electrodes such that protons can pass between the first and second electrodes across the PEM; such that the foraminous metallic substrate provides support for the PEM.

Preferably, the step of manufacturing a PEM includes the step of applying a treatment to the PEM. Preferably, the method includes the further step of integrally bonding together the first electrode and the PEM. The method preferably includes the further step of integrally bonding together the second electrode and the PEM. More preferably, the steps of integrally bonding together the first electrode and the PEM, and the second electrode and the PEM, are both carried out in the step of hot pressing together the first electrode, PEM, and second electrode.

The first electrode is preferably manufactured with a predetermined proportion of open area and a predetermined contact area, and the method preferably includes configuring the open area to optimise the flow of a predetermined fluid through the open area, whilst optimising the contact area available as electrochemical reaction sites.

The step of manufacturing the first electrode preferably includes weaving a first plurality of generally parallel metallic wires together with a second plurality of generally parallel metallic wires disposed generally orthogonal to the first plurality of wires to form a mesh that defines the foraminous metallic substrate.

In one embodiment, each wire is weaved alternately over and under another wire. In another embodiment, each wire is weaved alternately over two other wires and under two further wires.

The step of manufacturing the first electrode preferably includes pressing the substrate to reduce the thickness of the substrate. Preferably, the step of manufacturing the first electrode includes pressing the mesh to increase the contact between the wires. Also, the step of manufacturing the first electrode preferably includes pressing the mesh to reduce the undulations of the woven wires.

The step of manufacturing the first electrode preferably includes pressing the mesh to optimise the proportion of open area and the contact area, such that the fluid flow to and from the interface between the first electrode and the PEM, and the contact between the first electrode and the PEM are optimised.

The step of manufacturing the first electrode preferably includes applying a coating to the foraminous metallic substrate, the coating including a catalyst. Preferably, the coating includes an oxygen evolving catalyst. The step of manufacturing the first electrode also preferably includes applying a coating to the foraminous metallic substrate, with the coating including an ionomer. More preferably, the step of manufacturing the first electrode includes applying a coating to the foraminous metallic substrate, the coating including a catalyst ink having a noble metal catalyst powder and an ionomer.

Preferably, a coating including platinum is applied to the foraminous metallic substrate. Preferably, the step of manufacturing the first electrode includes applying a coating to the foraminous metallic substrate, the coating including one or more of palladium, nickel, gold, silver, and alloys constituting one or more of palladium, nickel, gold, and silver. In one embodiment, the step of manufacturing the first electrode includes applying a corrosion protection coating to the foraminous metallic substrate. In another embodiment, the step of manufacturing the first electrode includes integrating a corrosion protection mechanism into the foraminous metallic substrate.

The foraminous metallic substrate preferably can be manufactured from titanium. The foraminous metallic substrate can be manufactured from one or more of stainless steel, mild steel, nickel, niobium, and tantalum. The foraminous metallic substrate can be manufactured in the form of a multi-perforate metallic sheet. The foraminous metallic substrate can be manufactured in the form of a porous metallic sheet.

In one embodiment, the step of manufacturing the PEM includes depositing an oxygen evolving catalyst onto the PEM, and the step of manufacturing the first electrode includes applying a corrosion protection coating to the foraminous metallic substrate, the method including the further step of hot pressing together the first electrode, the PEM, and the second electrode.

### BRIEF DESCRIPTION OF THE DRAWINGS

Benefits and advantages of the present invention will become apparent to those skilled in the art to which this invention relates from the subsequent description of exemplary embodiments and the appended claims, taken in conjunction with the accompanying drawings, in which:

FIG. 1 is a schematic representation of a membrane electrode assembly (MEA) in accordance with an embodiment of the first aspect of the present invention;

FIG. 2 is a graph showing the performance of a 9 cm² active area electrolysis cell producing hydrogen incorporating a MEA in accordance with another embodiment of the first aspect of the present invention;

FIG. 3 is a graph showing the voltage-current characteristics of 9 cm², 50 cm², and 100 cm² active area cells/stacks incorporating MEAs in accordance with further embodiments of the first aspect of the present invention;

FIG. 4 is a graph showing the performance of a 2 kW H₂ electrolysis stack incorporating MEAs in accordance with further embodiments of the first aspect of the present invention; and

FIG. 5 is a graph showing the performance of a MEA in accordance with another embodiment of the first aspect of the present invention, operating at pressures up to 6 bar.

### DETAILED DESCRIPTION OF THE PREFERRED AND OTHER EMBODIMENTS

The membrane electrode assembly (MEA) of the preferred embodiment has been developed for hydrogen generation at high pressures and at high current densities while maintaining high efficiency.

In some embodiments, a woven (single or double strand) metallic (such as stainless steel, titanium or its alloys, nickel and its alloys) mesh of thickness 0.2 to 0.6 mm, with reasonably high resistance to corrosion, is used as a support for the oxygen electrode (catalyst) and is an integral part of the MEA. The contact area on one side of the mesh provides electrical contact with the flow fields in the interconnect, and on the other side, provides a base for catalyst deposition, and is therefore responsible for electron exchange between the interface and the interconnect. The open area provides the fluid (water and oxygen) exchange between the interface and the flow channels in the interconnect.

The mesh can be given a dimensional treatment by pressing to obtain the required thickness and morphology in terms of open area to contact area ratio, reducing surface roughness and enhancing the area available for electrical contacts with the catalyst and membrane as well as the interconnect. The pressing of the mesh results in a reduction in thickness, contributing to lowering the ohmic losses due to thickness, and an increase in the contact area to open area ratio, and contact between the overlapping wires.

The starting raw material and the dimensional modification of the mesh by pressing advantageously provides the required physical properties of the electrode support material. Such a support material advantageously allows generation of oxygen at high pressures with electrochemical compression without the need to externally pressurise the electrolysis stack. Further, the support material can be given surface treatment by etching and subsequent corrosion protection by electroplating or sputter coating. The support material can then be subjected to oxygen electrode catalyst layer deposition and fabricated as an integral part of the MEA in accordance with the invention.

In summary, the mesh constructed in accordance with the teachings of the preferred embodiment has the following advantages:
the mesh not only provides an electrical contact between the interconnect and the catalyst and membrane, but also allows water and oxygen gas exchange between the flow channels of the interconnect and the interface to carry out electrochemical reactions efficiently;
the physical and electrical properties of the mesh can be optimised by choosing the material and making modifications to the material, such as adding a corrosion protection coating, varying the thickness of the mesh, the type of mesh (weave style and number of strands), open area to contact area ratio, strand diameter;
the mesh supports MEAs on the oxygen side of the membrane, allowing higher pressures to be present on the hydrogen side, thereby making it possible to generate hydrogen at high pressures, while keeping atmospheric pressures on the oxygen/water side of the cell;
the physical properties of the mesh can be controlled to optimise catalyst layer deposition (at the interface between electrode and electrolyte), and allow higher hydrogen pressure operation, since the maximum pressure at which hydrogen can be generated would depend on the physical properties of the mesh and the electrolyte membrane, and the design of the mesh;
the mesh eliminates the use of a diffusion layer, such as carbon paper or cloth, as used in polymer electrolyte membrane based fuel cells.

The electrode supported MEAs prepared using the metallic mesh preparation process of the preferred embodiment, and used in the construction of electrolysis stacks, have been found to produce high current densities, up to 2 A.cm⁻², with catalyst loading as low as less than 0.3 mg.cm⁻². A stack efficiency of over 85% has been achieved at current densities as high as 1 A.cm⁻². A single MEA in accordance with the present invention has also been tested for hydrogen generation at pressures of up to 6 barA, without external mechanical compression. Higher pressure operation is also possible with the MEA of the present invention. The MEA of the present invention can be used to generate hydrogen at end use sites (distributed generation) at high pressures and at high current densities (higher hydrogen generation capacity per unit area) while maintaining high efficiency. The oxygen electrode supported MEA of the present invention has been demonstrated in single cells as well as stacks of sizes up to 15 cells, each having an active area of 100 cm², and with the stack producing up to 2 kW H₂.

FIG. 1 shows a schematic view of the various components of the membrane electrode assembly (MEA) constructed in accordance with the teachings of the preferred embodiment. The MEA, in the form of an electrolysis cell for generating hydrogen 1, includes a first electrode in the form of an oxygen electrode 2, and a second electrode in the form of a hydrogen electrode 3. A proton exchange membrane (PEM), in the form of a polymer electrolyte membrane 4, is interposed between the oxygen and hydrogen electrodes 2 and 3 such that protons can pass between the oxygen and hydrogen electrodes across the PEM. The oxygen electrode 2 has a foraminous metallic substrate, in the form of a mesh 5, to provide support for the PEM 4.

In the present embodiment, the hydrogen electrode 3 consists of diffusion, catalyst and ionomer layers supported on a carbon paper support 6 with a porous structure. The diffusion layer is made up of high surface carbon powder and PTFE. PTFE is added to make the layer hydrophobic for easy water removal. The catalyst layer is made up of ionomer and a noble metal catalyst supported on a high surface area carbon powder. The ionomer layer is made up of electrolyte material for good bonding to the electrolyte membrane and to maximise the triple phase boundaries at the interface.

The oxygen electrode 2 consists of catalyst and ionomer layers supported on the metallic mesh 5. In this particular embodiment, the mesh 5 is a pressed Ti mesh (optimised through an extensive procedure involving physical and chemical treatments) with a preliminary coating of Pt to provide further corrosion protection to the Ti material and the catalytic sites which in turn are further coated with an oxygen evolving catalyst and an ionomer using a specially formulated ink.

The mesh 5 provides mechanical support on the oxygen side of the MEA 1 when the hydrogen side of the MEA is pressurised, and therefore, allows operation of the electrolyser at high pressures. It also allows flow of water to three phase boundaries between the electrode, the electrolyte and water (reactant), and allows the escape of oxygen formed at the interface.

The oxygen electrode 2 and the PEM 4 are integrally bonded together. The hydrogen electrode 3 and the PEM 4 are also integrally bonded together. This is achieved by having the oxygen electrode, PEM, and hydrogen electrode hot pressed together.

The mesh 5 has a predetermined proportion of open area and a predetermined contact area, the open area being configured to optimise the flow of a predetermined fluid through the open area, whilst optimising the contact area available as electrochemical reaction sites.

Optimisation of open area and effective contact area between electrode and electrolyte and three-phase boundary area is critical for the performance (in terms of current densities and efficiencies achievable) of the MEA. As a variation instead of using a mesh, a perforated sheet of metal, a porous (through pores) metal or a metallic sponge can also be used and optimised for the electrochemical interface requirements.

Titanium in the form of mesh as well as porous sintered titanium sheets can be used. However, a mesh produces much better performance, due probably to the easy water and oxygen exchange through the pores of the titanium mesh. The mesh 5 is defined by a first plurality of generally parallel metallic wires weaved together with a second plurality of generally parallel metallic wires disposed generally orthogonal to the first plurality of wires.

Generally, there are two types of mesh weaves available: plain weave and twill weave. In plain weaves, each wire passes alternately over and under the wires at right angle. In the case of twill weaves, each wire passes alternately over two wires and under two wires. The latter weave provides more flat areas (due to a lesser number of humps), thereby providing a larger interfacial area, and therefore, a greater number of catalyst sites. Among twill weave meshes, 60×60 wires/inch mesh with 0.009″ diameter wires were found to produce the best performance among various meshes evaluated, probably due to the right combination of physical and electrical properties (% open area for water and oxygen transport to and from electro-active sites, flat area for catalyst deposition, and right wire diameter to achieve sufficient current carrying capacity). As a variation to the above mesh design (twill), other designs with different weave, openings, wire thickness, number of strands per unit area etc. can also be used to further optimise the oxygen electrode support.

Titanium shows outstanding resistance to salt water, is virtually immune to atmospheric corrosion, and is highly resistant to metallic salts, chlorides, hydroxides, nitric and chromic acids, organic acids and dilute alkalies. Furthermore, titanium has been the traditional substrate material used for oxygen evolving electrodes. As a variation to the titanium metal, other corrosion resistant metals or alloys (such as stainless steel, nickel etc.) or metals with protective coatings can also be used for oxygen electrode support.

The pressing of the mesh apart from thickness reduction and thickness uniformity over the entire surface, has following additional benefits:
an increase in the contact between the two woven wires resulting in reduction in the contact resistance between wires. In one embodiment, the wire diameter is 0.229 mm (0.009″). Therefore, the thickness of the mesh with two overlapping wires should be 0.458 mm. The actual thickness of the pressed mesh has been found to be around 0.4 mm. Therefore, each overlapping wire at the point of contact has been reduced vertically by ˜29 μm, ensuring good electrical contacts between overlapping wires;
a decrease in the uneven distribution of hill heights (flaws during mesh manufacture) thus reducing the possibility of mesh embedding too deep into the membrane during MEA fabrication (see below) leading to cell failure; and
an increase in the available surface for catalyst deposition and reduction in the open area leading to an increase in the effective contact area between electrode and the electrolyte while maintaining enough open area for water penetration to three phase contacts and escape of oxygen formed in the electrochemical reaction.

In the preferred embodiment of the method of manufacturing a membrane electrode assembly, the MEA 1 described above is manufactured in accordance with the following steps.

Titanium mesh is cut to a slightly larger size (Each dimension ˜1% more) than the required active area of the MEA. The mesh is then pressed for aforementioned reasons using a hydraulic press at 1.2 tons/cm² load. A special die is used that consists of a hardened 0.40 mm thick sheet spacer around the mesh and hardened (tool steel) blocks with alignment pins to press the mesh for maintaining a narrow thickness tolerance (0.400±0.005 mm) of the mesh. Assuming open area reduction proportional to thickness reduction, the open area after pressing is calculated to be ˜13% as compared to the original open area of 21.2%. The sides are then trimmed to achieve exact dimensions equivalent to active area of the cell. A second pressing at the same load is essential to remove sharp/bent edges of the mesh. The mesh thickness is measured at several points to ensure thickness uniformity.

As an alternative to pressing of the mesh, the mesh can be obtained (or manufactured) at the first instant with optimized openings to land (contact) areas ratio. In that case only minor pressing may be required to make a good contact between different strands of wire. Other types of titanium meshes given in the following table were also tested in the electrolysis MEAs but the performance was found to be inferior to the 60×60 wires/inch mesh with 0.009″ diameter wires.

| | | | | Width | |
|---|---|---|---|---|---|
| | Mesh | Wire Diameter, | Type of | Opening | % Open |
| No. | (Wires/Inch) | (Inch) | Weave | (Inch) | Area |
| 1 | 60 × 60 | 0.0090 | Twill | 0.0077 | 21.2 |
| 2 | 120 × 120 | 0.0040 | Twill | 0.0043 | 27.0 |
| 3 | 150 × 150 | 0.0027 | Twill | 0.0040 | 35.4 |

The mesh is acid cleaned to remove any dirt, grease or oxide layer. The mesh is cleaned in hot hydrochloric acid (70° C.) to remove surface contaminations, rinsed in Millipore water, dried in a vacuum oven and stored for further processing. The cleaning process described above has been found to be adequate but can be further optimised to reduce cleaning steps and time. As a variation there can be other methods of cleaning the mesh such as sand blasting, electrochemical etching etc.

Platinum is used as the coating material to provide corrosion resistance as well as a catalytic surface. The mesh is sputter coated uniformly with platinum as per following conditions: 4 minutes sputtering at a rate of approximately 27 nm/minute to achieve ˜0.18 mg/cm² loading. As a quality control check, the mesh is weighed to determine the amount of platinum deposited on the mesh. The mesh is then stored for further processing as described below. As a variation the mesh can also be coated with other noble metals such as palladium, gold, silver, etc., by using different methods of coating such as electroplating, thermo chemical deposition, etc. Also mesh without any coating may give reasonable lifetime.

The following procedure is adopted to form a catalyst 7 and an ionomer layer 8 on the titanium mesh support. Catalyst ink is prepared using the constituents: noble metal catalyst powder such as platinum black, ruthenium black, iridium black, ruthenium oxide, iridium oxide etc.—individually or in combination; solvent such as iso-propyl alcohol, butyl acetate, etc.; and ionomer such as Nafion solution. The mixture of above constituents can be ball milled to make a smooth homogeneous solution (ink). This solution is given ultrasonic treatment just before using it. The titanium mesh is then coated with ink. The catalyst ink is dried in atmosphere and then in a vacuum oven at 50-80° C. for 1 hour. The mesh is weighed to determine the total catalyst loading achieved (recommended 0.2-0.3 mg/cm²) on the titanium mesh. The mesh is then coated with 5% Nafion solution. The ionomer layer is dried first in atmosphere and then in vacuum oven at 50-80° C. The Nafion loading obtained is in the range 0.4-0.5 mg.cm⁻². The mesh is stored for MEA assembly.

The membrane is protonated by treatment with sulphuric acid solution.

The membrane electrode assembly (mesh with catalyst and ionomer layer, protonated membrane and hydrogen electrode (catalyst on carbon paper) were hot pressed at temperature in the range 120-140° C. for 1 minute. A special die with alignment pins and spacers was designed and used for this purpose.

As a variation, instead of forming catalyst layers on the oxygen electrode support (mesh) and hydrogen electrode support (carbon paper or cloth), can also be formed on both sides of the electrolyte membrane. In this case mesh would simply have a corrosion protection layer on its surface. The electrolyte membrane would be carrying oxygen catalyst layer on one side (titanium mesh would be in contact with this side) and hydrogen catalyst layer on the other side (carbon paper or cloth would be in contact with this side).

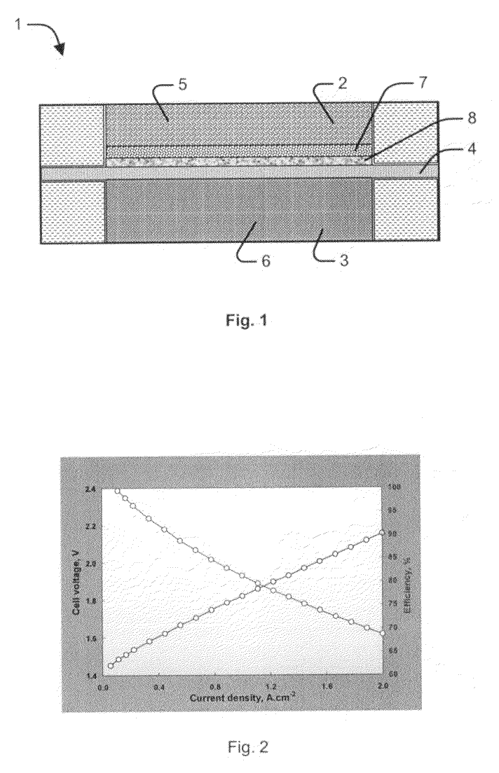

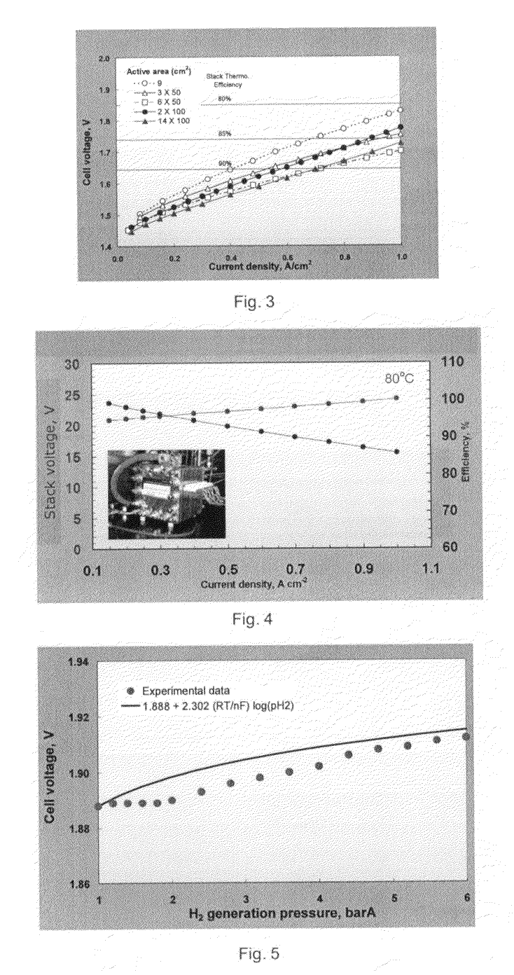

FIGS. 2, 3 and 4 show the performance of electrode supported MEAs fabricated using the above procedure and tested as a single cell configuration or as stacks. FIG. 2 shows typical voltage-current characteristics of a 9 cm² active area MEA up to 1 A.cm⁻² current densities. FIG. 3 shows the successful demonstration of scale-up of the technology in terms of cell size and stack size. FIG. 4 shows the performance of a 14 cell 100 cm² active area 2 kW H₂ PEM electrolysis stack. FIG. 5 shows the performance of the electrode supported MEAs at pressures to 6 barA.

Although the present invention has been described with particular reference to certain preferred embodiments thereof, variations and modifications of the present invention can be effected within the spirit and scope of the following claims.

We claim:

1. A membrane electrode assembly (MEA) for an electrochemical cell including:
a first electrode;
a second electrode; and
a proton exchange membrane (PEM) interposed between the first and second electrodes such that protons can pass between the first and second electrodes across the PEM; wherein
the first electrode has a foraminous metallic substrate to provide support for the PEM.

2. A membrane electrode assembly as claimed in claim 1 wherein the first electrode and the PEM are integrally bonded together.

3. A membrane electrode assembly as claimed in claim 2 wherein the second electrode and the PEM are integrally bonded together.

4. A membrane electrode assembly as claimed in claim 3 wherein the first electrode, PEM, and second electrode are hot pressed together.

5. A membrane electrode assembly as claimed in claim 1 wherein the foraminous metallic substrate has a predetermined proportion of open area and a predetermined contact area, the open area being configured to optimise the flow of a predetermined fluid through the open area, whilst optimising the contact area available as electrochemical reaction sites.

6. A membrane electrode assembly as claimed in claim 5 wherein the foraminous metallic substrate is a mesh defined by a first plurality of generally parallel metallic wires weaved together with a second plurality of generally parallel metallic wires disposed generally orthogonal to the first plurality of wires.

7. A membrane electrode assembly as claimed in claim 6 wherein each wire passes alternately over and under another wire.

8. A membrane electrode assembly as claimed in claim 6 wherein each wire passes alternately over two other wires and under two further wires.

9. A membrane electrode assembly as claimed in claim 1 wherein the substrate is pressed to reduce the thickness of the substrate.

10. A membrane electrode assembly as claimed in claim 6 wherein the mesh is pressed to increase the contact between the wires.

11. A membrane electrode assembly as claimed in claim 6 wherein the mesh is pressed to reduce the undulations of the woven wires.

12. A membrane electrode assembly as claimed in claim 6 wherein the mesh is pressed to optimise the proportion of open area and the contact area, such that the fluid flow to and from the interface between the first electrode and the PEM, and the contact between the first electrode and the PEM are optimised.

13. A membrane electrode assembly as claimed in claim 1 wherein the foraminous metallic substrate has a coating that includes a catalyst.

14. A membrane electrode assembly as claimed in claim 13 wherein the coating includes an oxygen evolving catalyst.

15. A membrane electrode assembly as claimed in claim 1 wherein the foraminous metallic substrate has a coating that includes an ionomer.

16. A membrane electrode assembly as claimed in claim 1 wherein the foraminous metallic substrate has a coating that includes a catalyst ink having a noble metal catalyst powder and an ionomer.

17. A membrane electrode assembly as claimed in claim 1 wherein the foraminous metallic substrate has a coating that includes platinum.

18. A membrane electrode assembly as claimed in claim 1 wherein the foraminous metallic substrate has a coating that includes one or more of palladium, nickel, gold, silver, and alloys constituting one or more of palladium, nickel, gold, and silver.

19. A membrane electrode assembly as claimed in claim 1 wherein the foraminous metallic substrate has a corrosion protection coating.

20. A membrane electrode assembly as claimed in claim 1 wherein the foraminous metallic substrate has a built-in corrosion protection mechanism.

21. A membrane electrode assembly as claimed in claim 1 wherein the foraminous metallic substrate is made of titanium.

22. A membrane electrode assembly as claimed in claim 1 wherein the foraminous metallic substrate is made of one or more of stainless steel, mild steel, nickel, niobium, and tantalum.

23. A membrane electrode assembly as claimed in claim 1 wherein the foraminous metallic substrate is in the form of a multi-perforate metallic sheet.

24. A membrane electrode assembly as claimed in claim 1 wherein the foraminous metallic substrate is in the form of a porous metallic sheet.

25. A membrane electrode assembly as claimed in claim 1 wherein the PEM has a coating that includes an oxygen evolving catalyst, and the foraminous metallic substrate has a corrosion protection coating, the first electrode, the PEM, and the second electrode being hot pressed together.

26. A method of manufacturing a membrane electrode assembly, the method including the steps of:
manufacturing a first electrode having a foraminous metallic substrate;
manufacturing a second electrode;
manufacturing a proton exchange membrane (PEM);
interposing the PEM between the first and second electrodes such that protons can pass between the first and second electrodes across the PEM; such that
the foraminous metallic substrate provides support for the PEM.

27. A method as claimed in claim 26 wherein the step of manufacturing a PEM includes the step of applying a treatment to the PEM.

28. A method as claimed in claim 26 including the further step of integrally bonding together the first electrode and the PEM.

29. A method as claimed in claim 28 including the further step of integrally bonding together the second electrode and the PEM.

30. A method as claimed in claim 29 wherein the steps of integrally bonding together the first electrode and the PEM, and the second electrode and the PEM, are both carried out in the step of hot pressing together the first electrode, PEM, and second electrode.

31. A method as claimed in claim 26 wherein the first electrode is manufactured with a predetermined proportion of open area and a predetermined contact area, and the method includes configuring the open area to optimise the flow of a predetermined fluid through the open area, whilst optimising the contact area available as electrochemical reaction sites.

32. A method as claimed in claim 31 wherein the step of manufacturing the first electrode includes weaving a first plurality of generally parallel metallic wires together with a second plurality of generally parallel metallic wires disposed generally orthogonal to the first plurality of wires to form a mesh that defines the foraminous metallic substrate.

33. A method as claimed in claim 32 wherein each wire is weaved alternately over and under another wire.

34. A method as claimed in claim 32 wherein each wire is weaved alternately over two other wires and under two further wires.

35. A method as claimed in claim 26 wherein the step of manufacturing the first electrode includes pressing the substrate to reduce the thickness of the substrate.

36. A method as claimed in claim 32 wherein the step of manufacturing the first electrode includes pressing the mesh to increase the contact between the wires.

37. A method as claimed in claim 32 wherein the step of manufacturing the first electrode includes pressing the mesh to reduce the undulations of the woven wires.

38. A method as claimed in claim 32 wherein the step of manufacturing the first electrode includes pressing the mesh to optimise the proportion of open area and the contact area, such that the fluid flow to and from the interface between the first electrode and the PEM, and the contact between the first electrode and the PEM are optimised.

39. A method as claimed in claim 26 wherein the step of manufacturing the first electrode includes applying a coating to the foraminous metallic substrate, the coating including a catalyst.

40. A method as claimed in claim 39 wherein the coating includes an oxygen evolving catalyst.

41. A method as claimed in claim 26 wherein the step of manufacturing the first electrode includes applying a coating to the foraminous metallic substrate, the coating including an ionomer.

42. A method as claimed in claim 26 wherein the step of manufacturing the first electrode includes applying a coating to the foraminous metallic substrate, the coating including a catalyst ink having a noble metal catalyst powder and an ionomer.

43. A method as claimed in claim 26 wherein the step of manufacturing the first electrode includes applying a coating to the foraminous metallic substrate, the coating including platinum.

44. A method as claimed in claim 26 wherein the step of manufacturing the first electrode includes applying a coating to the foraminous metallic substrate, the coating including one or more of palladium, nickel, gold, silver, and alloys constituting one or more of palladium, nickel, gold, and silver.

45. A method as claimed in claim 26 wherein the step of manufacturing the first electrode includes applying a corrosion protection coating to the foraminous metallic substrate.

46. A method as claimed in claim 26 wherein the step of manufacturing the first electrode includes integrating a corrosion protection mechanism into the foraminous metallic substrate.

47. A method as claimed in claim 26 wherein the foraminous metallic substrate is manufactured from titanium.

48. A method as claimed in claim 26 wherein the foraminous metallic substrate is manufactured from one or more of stainless steel, mild steel, nickel, niobium, and tantalum.

49. A method as claimed in claim 26 wherein the foraminous metallic substrate is manufactured in the form of a multi-perforate metallic sheet.

50. A method as claimed in claim 26 wherein the foraminous metallic substrate is manufactured in the form of a porous metallic sheet.

51. A method as claimed in claim 26 wherein the step of manufacturing the PEM includes depositing an oxygen evolving catalyst onto the PEM, and the step of manufacturing the first electrode includes applying a corrosion protection coating to the foraminous metallic substrate, the method including the further step of hot pressing together the first electrode, the PEM, and the second electrode.
